(19) United States
(12) Patent Application Publication
(10) Pub. No.: US 2003/0177853 A1
(43) Pub. Date: Sep. 25, 2003

(54) Nonlinear mechanical modulator and actuation systems thereof

(76) Inventors: Young-Ho Cho, Daejeon (KR); Won Chul Lee, Gwangmyeong (KR); Young-Hyun Jin, Seoul (KR)

Correspondence Address: GRAYBEAL, JACKSON, HALEY LLP, 155 - 108TH AVENUE NE, SUITE 350, BELLEVUE, WA, 98004-5901, US

(21) Appl. No.: 10/357,763

(22) Filed: Feb. 3, 2003

(30) Foreign Application Priority Data
Mar. 21, 2002 (KR) 2002-15265

(51) Int. Cl. F16H 21/44

(52) U.S. Cl. 74/96

(57) ABSTRACT

The nonlinear mechanical modulator of the present invention comprises first and second masses, a first spring connecting the first and second masses, and a second spring connecting the second mass and a fixed end. A motion input is applied to any one of the first and second masses and a resultant motion output is generated from the other one of the masses. Further, at least one of the springs has a nonlinear behavior characteristic that its stiffness varies according to a magnitude of the motion input. At this time, a nonlinear characteristic of the spring is categorized into a nonlinearly increasing characteristic that its stiffness is increased as its deflection becomes greater, and a nonlinearly decreasing characteristic that its stiffness is decreased as its deflection becomes greater. One or both of the two nonlinear characteristics can be applied to and employed in the mechanical modulator of the present invention.

### PRIORITY CLAIM

This application claims priority from Korean patent application No. 2002-0015265 filed Mar. 21, 2002, which is herein incorporated by reference.

### BACKGROUND OF THE INVENTION

1. Field of the Invention

The present invention relates to mechanical modulators manufactured by the micro electro mechanical system (MEMS) technology and actuation systems thereof. More particularly, the present invention relates to the nonlinear mechanical modulators having a nonlinear relationship between their motion input and output, and the actuation systems thereof.

2. Description of the Prior Art

In general, a modulator is an apparatus for modulating an input and generating the modulated output. In particular, a modulator used in an electrical/electronic field is intended to modify the frequency or magnitude of the electrical input signals and to produce the modulated signals.

However, a mechanical modulator deals with mechanical signals, such as displacements or motion, thus, modifies the frequency and amplitude of input displacement or motion using a mechanical device. Therefore, the mechanical modulator can be referred to as a motion-transforming device. The conventional mechanical modulator is used such that it can generate the motion output linearly proportional to the motion input so as to linearly modulate the motion input to a desired level by increasing or decreasing motion amplitude.

As it is known from Chapter 14 of a book of which author is Hiromu Nakazawa and which is entitled “The Reduction Principle in Principles of Precision Engineering” and was published by Oxford University in 1994, the linear mechanical modulator is generally implemented by a lever mechanism using the principle of a lever or by a gear mechanism in which toothed wheels with different number of teeth are used.

On the other hand, as disclosed in a technical paper of H. Toshiyoshi, et al. entitled “Micro Electro Mechanical Digital-to-Analog Converter” and a technical paper of R. Yeh, et al. entitled “Mechanical Digital-to-Analog Converter,” the conventional linear mechanical modulator manufactured by the MEMS technology basically employs an spring shown in FIG. 1 so as to generate its motion output obtained by linearly modulating motion input from at least one actuator.

FIG. 1 shows a schematic diagram of the conventional mechanical modulator. As shown in the figure, the mechanical modulator comprises a first mass 1 for the motion input, a second mass 2 for the motion output, a first spring 3, a second spring 4, and a fixed end 5.

Hereinafter, the operation of the conventional mechanical modulator will be explained. If a motion input (displacement) is applied to the modulator, the first mass 1 moves by an amount of the applied motion input (displacement) which in turn results in deflection of the first spring 3. Thus, an elastic force is generated from the deformed spring 3, and the generated elastic force is exerted on the second mass 2 to produce a movement of the second mass 2. However, since the second spring 4 is interposed between the fixed end 5 and the second mass 2, the second spring 4 serves to reduce the motion of the second mass 2. Therefore, the second mass 2 comes to a stop at a position where the elastic forces of the first and second springs 3, 4 are in equilibrium with each other. That is, when the motion input is applied to the first mass, the motion output from the second mass is determined as a value obtained by multiplying the motion input by a stiffness ratio of the two springs.

The conventional mechanical modulator is generally referred to as the mechanical modulator in which both the first and second springs 3, 4 have linear characteristics as shown in FIG. 1. The aforementioned linear characteristics mean that the stiffness of the spring is not changed according to the magnitude of their own deflection. That is, a linear spring has constant stiffness regardless of whether its deflection magnitude is small or large.

FIG. 2 shows an embodiment of the linear mechanical modulator manufactured by the MEMS technology. This embodiment is composed of two folded beams 31, 41 as first and second linear springs 3, 4 in FIG. 1. Further, an actuator 6 is attached to the first mass 1 in order to supply the motion input.

According to the aforementioned linear mechanical modulator, the stiffness of the first and second springs 3, 4 are always kept constant even though the motion input applied thereto may be changed. The stiffness ratio of the two springs is also kept constant regardless of the change in the motion input. The motion output, the product of the motion input and the stiffness ratio of the two springs, is linearly proportional to the motion input as shown in FIG. 3.

Here, the relationship between the motion input and output of the linear mechanical modulator illustrated in FIGS. 1 and 2 is expressed as the following equation (1). The equation (1) is easily derived from the force-equilibrium in the second mass 2. The forces from the first and second springs 3, 4 are canceled.

$${X}_{out} = ( \frac{{k}_{1}}{{k}_{1} + {k}_{2}} ) {X}_{in} \qquad ( 1 )$$

where, Xₒᵤₜ is a moved displacement of the second mass 2 (hereinafter, referred to as “motion output”), Xᵢₙ is a moved displacement of the first mass 1 (hereinafter, referred to as “motion input”), k₁ is the stiffness of the first spring 3, and k₂ is the stiffness of the second spring 4.

It is understood from the equation (1) that the motion output Xₒᵤₜ is obtained from multiplying the motion input Xᵢₙ by the stiffness ratio of the first and second springs 3, 4. Further, since the stiffness of the first and second linear springs 3, 4 or 31, 41 is constant irrespective of the deflection thereof, a relations between the motion output Xₒᵤₜ and the motion input Xᵢₙ is shown in the form of a linear modulation curve in FIG. 3.

FIG. 3 shows the characteristic of the motion input and output for the conventional mechanical modulator, in which a horizontal axis represents the motion input Xᵢₙ of the mass and a vertical axis represents the motion output Xₒᵤₜ of the mass.

Next, a motion error in the linear mechanical modulator will be discussed. A motion input Xᵢₙ₁ is supplied into the mechanical modulator from the actuator. At this time, the motion input error δXᵢₙ₁ is included in the motion input Xᵢₙ₁ due to the instability of fabrication technology. That is, the motion input substantially applied to the linear mechanical modulator becomes a value, Xᵢₙ₁±δXᵢₙ₁ in which the motion input error is added to the motion input.

In a case where the motion input Xᵢₙ₁±δXᵢₙ₁ including such an error is applied to the linear mechanical modulator, the motion output is also obtained as a value in which the motion output error δXₒᵤₜ₁ is added to an expected motion output Xₒᵤₜ₁.

As shown in FIG. 3, a ratio of the motion output error δXₒᵤₜ₁ to the motion input error δXᵢₙ₁ is equal to a constant gradient Xₒᵤₜ₁/Xᵢₙ₁ of the modulation curve, which is expressed as the following equation (2).

$$δ {X}_{out1} = ( \frac{{X}_{out1}}{{X}_{in1}} ) δ {X}_{in1} \qquad ( 2 )$$

The equation (2) can be simply modified to the following equation (3).

$$\frac{δ {X}_{out1}}{{X}_{out1}} = \frac{δ {X}_{in1}}{{X}_{in1}} \qquad ( 3 )$$

A left side δXₒᵤₜ₁/Xₒᵤₜ₁ of the equation (3) means a relative error of the motion output, and a right side δXᵢₙ₁/Xᵢₙ₁ of the equation (3) means a relative error of the motion input. That is, the equation (3) means that the relative errors of the motion input and the motion output are equal to each other.

Therefore, the conventional linear mechanical modulator has a problem in that the relative error of the motion output cannot be reduced because the relative error of the motion input is transmitted to the motion output.

### SUMMARY OF THE INVENTION

Accordingly, the present invention is conceived to solve the problem in the prior art. An object of the present invention is to provide a nonlinear mechanical modulator for reducing the relative error of a motion output.

According to an aspect of the present invention, there is provided a nonlinear mechanical modulator which comprises a plurality of masses including a first mass to which an motion input is applied and a second mass from which an motion output is generated, and a plurality of springs including first and second springs which are connected to the first and second masses, respectively. Further, at least one of springs has a nonlinear characteristic that its stiffness varies according to its deflection.

Preferably, one or more of the springs placed between the mass for the motion input and the mass for the motion output have nonlinearly decreasing characteristics that their stiffness is decreased as their deflection becomes greater, and the one or more of the springs placed between the mass for the motion output and a fixed end have nonlinearly increasing characteristics that their stiffness is increased as their deflection becomes greater.

The nonlinear mechanical modulator according to the present invention can be fabricated with an actuator through the single process in order to provide an actuation system. At this time, the actuation system as of the present invention can be designed in such a manner that when identical changes occur in dimensions of the mechanical modulators and the magnitudes of the motion input, the influence of the identical changes to the motion output is compensated and the motion output of the actuation system is remained in the constant magnitude.

### BRIEF DESCRIPTION OF THE DRAWINGS

The above and other objects, advantages and features of the present invention will become apparent from the following description of preferred embodiments given in conjunction with the accompanying drawings, in which:

FIG. 1 shows a model of a mechanical modulator;

FIG. 2 shows a schematic view of a conventional linear mechanical modulator;

FIG. 3 shows a motion modulation curve, xᵢₙ−xₒᵤₜ, of the conventional linear mechanical modulator;

FIG. 4 shows a schematic view of a nonlinear mechanical modulator according to a first embodiment of the present invention;

FIGS. 5a and 5b show a linear spring comprised of folded beams and its deformation;

FIGS. 6a and 6b show a nonlinear spring comprised of fixed-fixed beams and its deformation;

FIG. 7 shows deflection-force curves of the folded beams and the fixed-fixed beams for the mechanical modulator according to the present invention;

FIG. 8 shows a motion modulation curve, xᵢₙ−xₒᵤₜ, of the nonlinear mechanical modulator according to the first embodiment of the present invention;

FIGS. 9a and 9b show schematic views of the linear mechanical modulator and the nonlinear mechanical modulator attached to identical digital microactuators, respectively;

FIGS. 10a and 10b show motion modulation curves of the linear and nonlinear mechanical modulators, respectively;

FIG. 11 shows a fabrication process for the linear and nonlinear modulators attached to digital microactuators;

FIG. 12a is a scanning electron micrograph of the linear mechanical modulator attached to the digital microactuator;

FIG. 12b is a scanning electron micrograph of the linear mechanical modulator, which is an enlarged view from FIG. 12a;

FIG. 13a is a scanning electron micrograph of the nonlinear mechanical modulator attached to the digital microactuator;

FIG. 13b is a scanning electron micrograph of the nonlinear mechanical modulator, which is an enlarged view from FIG. 13a;

FIG. 14a shows a measured motion output signal;

FIG. 14b is an enlarged view. of the portion C in FIG. 14a;

FIGS. 15a and 15b show motion modulation curves of the linear and nonlinear mechanical modulators, respectively;

FIG. 16 shows a model of a nonlinear mechanical modulator according to a second embodiment of the present invention.

### DETAILED DESCRIPTION OF THE INVENTION

Hereinafter, preferred embodiments of a nonlinear mechanical modulator according to the present invention will be explained in detail with reference to the accompanying drawings.

FIG. 4 shows the constitution of the nonlinear mechanical modulator according to a first embodiment of the present invention. The nonlinear mechanical modulator according to the first embodiment of the present invention comprises a first mass 10, a second mass 20, a first linear spring 30, a second spring 40 having a nonlinearly increasing characteristic, a fixed end 50, and a constant stroke actuator 60.

When a motion input generated by the actuator 60 is applied to the first mass 10, the first mass 10 is moved accordingly.

At this time, the first spring 30 is a spring comprised of folded beams connected to the first and second masses 10, 20. The first spring 30 generates an elastic force caused by the motion input of the first mass 10 to be applied to the second mass 20.

Then, the second mass 20 receives the elastic force caused from the first spring 30, and is consequently moved. This movement becomes a motion output of the mechanical modulator. At this time, the second spring 40 is a spring comprised of fixed-fixed beams. The second spring 40 reduces the motion of the second mass 20.

A relationship between the motion input and output of the nonlinear mechanical modulator of the present invention is equally expressed as the equation (1).

However, contrary to the prior art, the second spring 40 of the nonlinear mechanical modulator has the nonlinearly increasing characteristic that its stiffness k2 is increased as its deflection is increased.

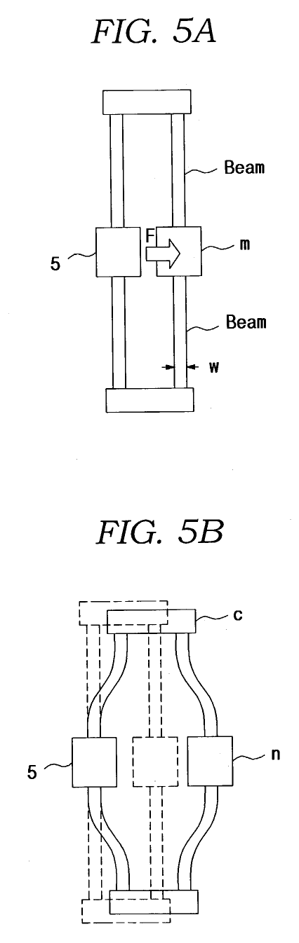

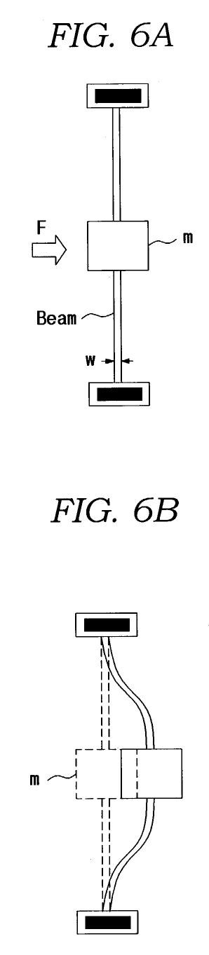

The nonlinearly increasing characteristic of the second spring 40 in the form of the fixed-fixed beam will be explained with reference to FIGS. 5a, 5b, 6a and 6b.

FIGS. 5a and 5b show a deformation of the folded beam which is the linear spring. As shown in FIG. 5a, the folded beam is constructed in such a manner that a pair of two beams with a width of w are placed side by side at both ends of the mass m and the supporting end 5 and are connected with each other by connection bodies c. If the mass m connected to the folded beam is subjected to an external force and moved in a direction of an arrow F, the beams are deformed as shown in FIG. 5b. The deflection of the beam causes the mass m and the connection body c to be moved in the F direction while the fixed end 5 is not moved.

On the other hand, FIGS. 6a and 6b show deformation of the fixed-fixed beam which is a nonlinear spring. As shown in FIG. 6a, the fixed-fixed beam is in the form of a straight line. Two beams with a width of w are connected between the mass m and the two fixed ends 50 placed on both sides. If the mass m connected to the fixed-fixed beam is subjected to a force and moved in a direction of an arrow F, the beams at both sides are deflected as shown in FIG. 6b. The deflection of the beam causes the mass m to be moved in the F direction while the fixed ends 50 are not moved.

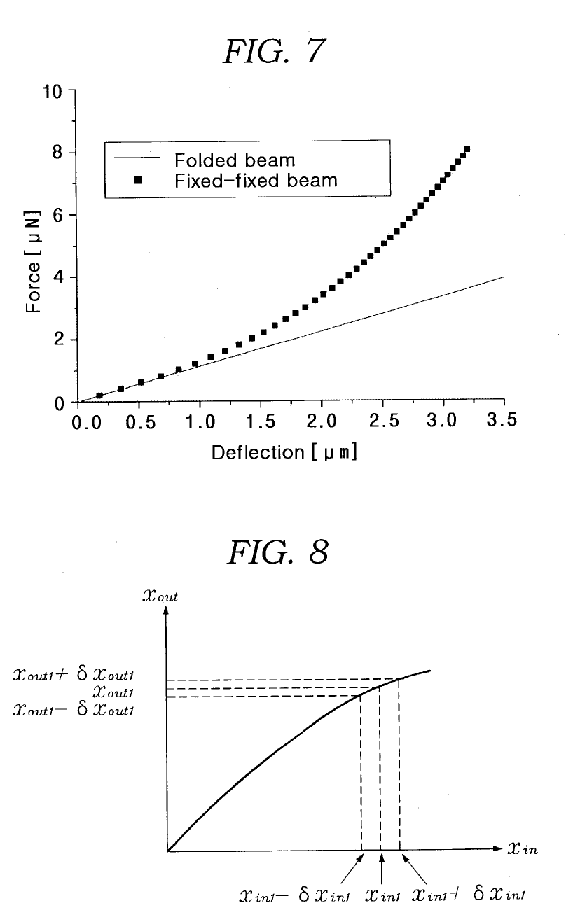

If any deflection with similar length of the beam-width occurs in the second spring 40 which is deflected as shown in FIG. 6, the fixed-fixed beam is not only bent but also extended. Thus, as shown in FIG. 7, the stiffness is increased as the deflection is increased because the extension-stiffness is added. However, in case of the folded beam which is deflected as shown in FIG. 5b, if any deflection, the two connection bodies c can move inwardly toward each other, and thus, the extension stiffness is not added. Therefore, the total stiffness is not further increased.

Accordingly, the spring comprised of the fixed-fixed beam employed in the first embodiment of the present invention behaves according to a nonlinear force-deflection curve even within a deflection range of a linear force-deflection curve comprised of the folded beam.

As a result, the relationship between the motion input and output according to the first embodiment of the present invention has a nonlinear modulation characteristic. As shown in FIG. 8, the increase of the motion output is gradually decreased as the motion input is increased.

Hereinafter, an effect of an input error exerted on the motion output will be explained in a case where an motion input including the error is applied to the nonlinear mechanical modulator of the present invention.

In the same manner as the linear mechanical modulator, if the motion input including the input error Xᵢₙ₁±δXᵢₙ₁ is applied to the nonlinear mechanical modulator, the motion output including an output error Xₒᵤₜ₁±δXₒᵤₜ₁ is generated. At this time, a ratio of the motion output error δXₒᵤₜ₁ to the motion input error δXᵢₙ₁ according to the first embodiment of the present invention is proportional to the gradient of the modulation curve, and is expressed as the following equation (4).

$$δ {X}_{out1} = {( \frac{ⅆ {X}_{out1}}{ⅆ {X}_{in}} )}_{{X}_{in} = {X}_{in1}} \times δ {X}_{in1} , \qquad ( 4 )$$

where (dXₒᵤₜ/dXᵢₙ)ₓ_{ᵢₙ}₌ₓ_{ᵢₙ₁} is a gradient of the modulation curve at a point where the motion input is Xᵢₙ₁.

By rearranging the equation (4) into the following equation (5), a relationship between a relative error δXᵢₙ₁/Xᵢₙ₁ of the motion input and a relative error δXₒᵤₜ₁/Xₒᵤₜ₁ of the motion output can be easily understood.

$$\frac{δ {X}_{out1}}{{X}_{out1}} = [ {( \frac{ⅆ {X}_{out}}{ⅆ {X}_{in}} )}_{{X}_{in} = {X}_{in1}} / \frac{{X}_{out1}}{{X}_{in1}} ] \times \frac{δ {X}_{in1}}{{X}_{in1}} \qquad ( 5 )$$

In the nonlinear mechanical modulator which behaves according to the nonlinear modulation curve shown in FIG. 5, the gradient of the modulation curve (dXₒᵤₜ/dXᵢₙ)ₓ_{ᵢₙ}₌ₓ_{ᵢₙ₁} is always lower than the input-to-output ratio Xₒᵤₜ₁/Xᵢₙ₁, as shown in the following relationship [1].

$${( \frac{ⅆ {X}_{out}}{ⅆ {X}_{in}} )}_{{X}_{in} = {X}_{in1}} < \frac{{X}_{out1}}{{X}_{in1}} \qquad [ 1 ]$$

Further, the following relationship [2] can be obtained from the relationship [1] and the equations (4) and (5). The relative error of the motion output is smaller than the relative error of the motion input in the nonlinear mechanical modulator according to the first embodiment of the present invention.

$$\frac{δ {X}_{out1}}{{X}_{out1}} < \frac{δ {X}_{in1}}{{X}_{in}} \qquad [ 2 ]$$

Thus, it can be understood from the relationships [1] and [2] and the equations (4) and (5) that the relative error of the motion output is reduced to be smaller than the relative error of the motion input in the mechanical modulator according to the first embodiment of the present invention.

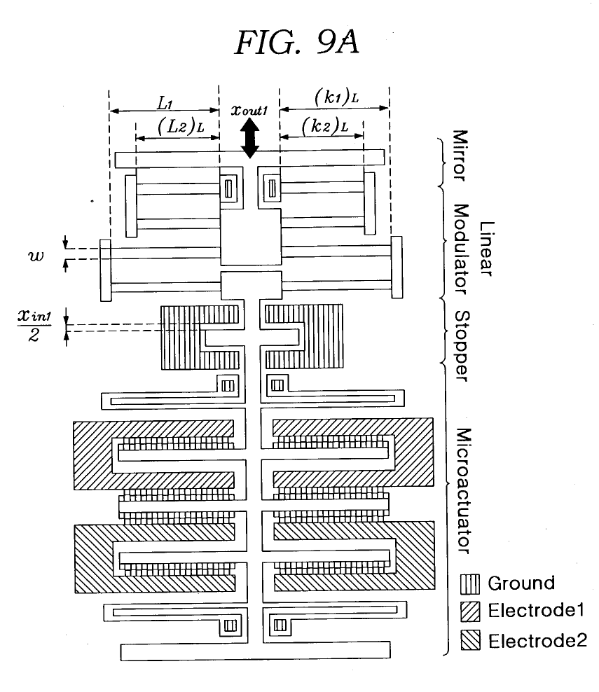

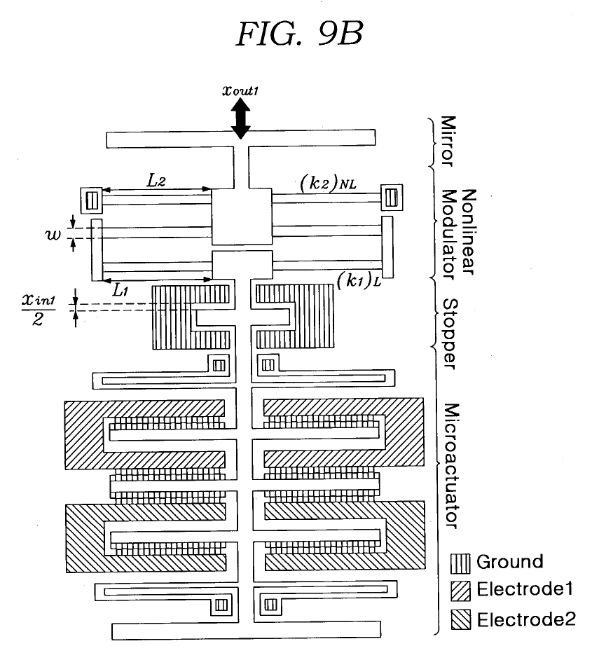

Two kinds of prototypes are designed, fabricated and characterized for the experimental evaluation of the nonlinear mechanical modulator according to the first embodiment of the present invention. As shown in FIG. 9 and Table I, identical digital microactuators are attached to the linear and nonlinear micromechanical modulators in two prototypes (hereinafter, referred to as ‘linearly modulated digital microactuator(LMDA)’ and ‘nonlinearly modulated digital microactuator(NMDA)’, respectively). Microactuators provide the digital motion (xᵢₙ) of 15.2 μm to the first mass 1 of the micromechanical modulators using motion-limiting function of the mechanical stoppers.

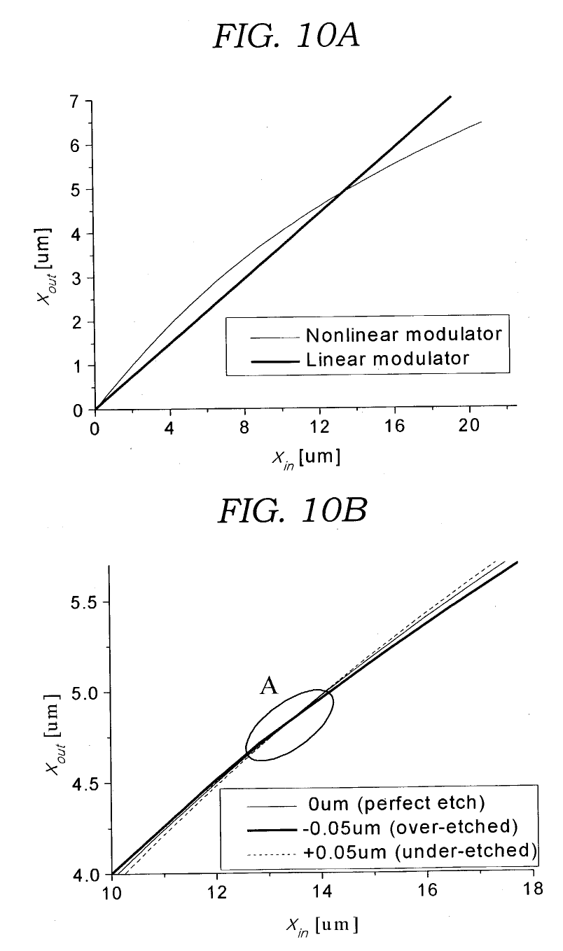

As mentioned above, micromechanical modulators utilize the folded beams and the fixed-fixed beams as the linear and nonlinear springs, respectively. Using the finite element method and above equations, we obtain the motion modulation curves (FIG. 10) of the linear and nonlinear modulators, having an identical input and output pair of 15.2 μm and 5.4 μm.

To evaluate the precision of the actuation, we defined the repeatability as the double of the standard deviation in the repeated actuation. In the case of a digital actuator fabricated by deep RIE (Reactive Ion Etching) process, the repeatability (δXᵢₙ) is about 70.7 nm, due to the sidewall roughness of the mechanical stoppers in the order of ±0.05 μm. We can calculate the repeatability of the linearly and nonlinearly modulated motion outputs (δXₒᵤₜ) as 25.8 nm and 15.4 nm, respectively.

Additionally, we have examined the variation of the modulated outputs in the LMDA and NMDA, when the whole device has been under- or over-etched. In the portion A of FIG. 10b, we find that NMDA also maintains stable motion output against the over-etching and under-etching of the micromechanical beam springs and micromechanical stoppers.

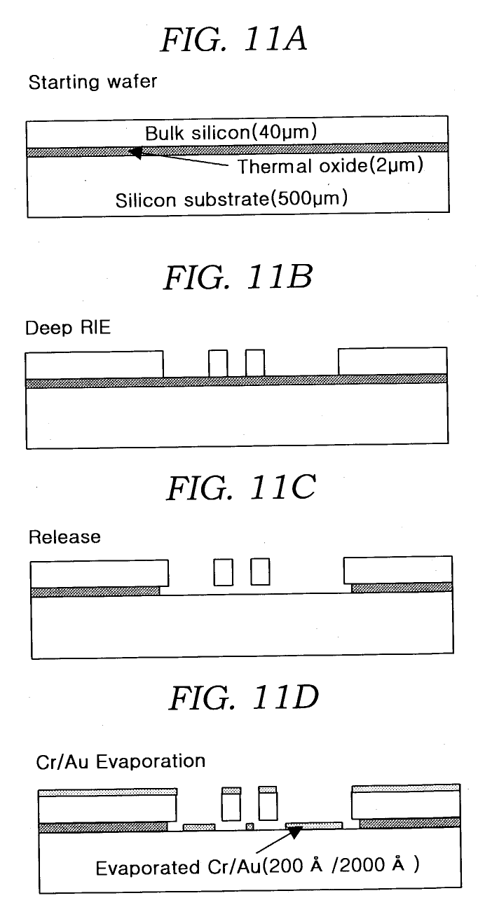

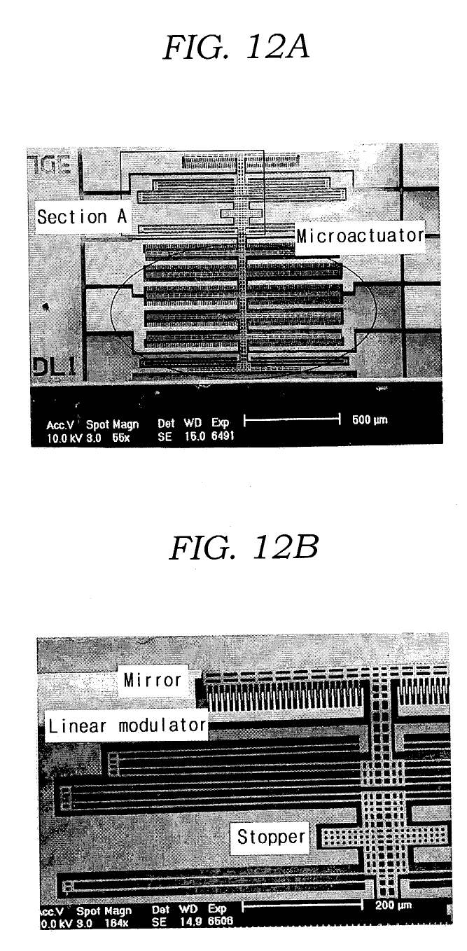

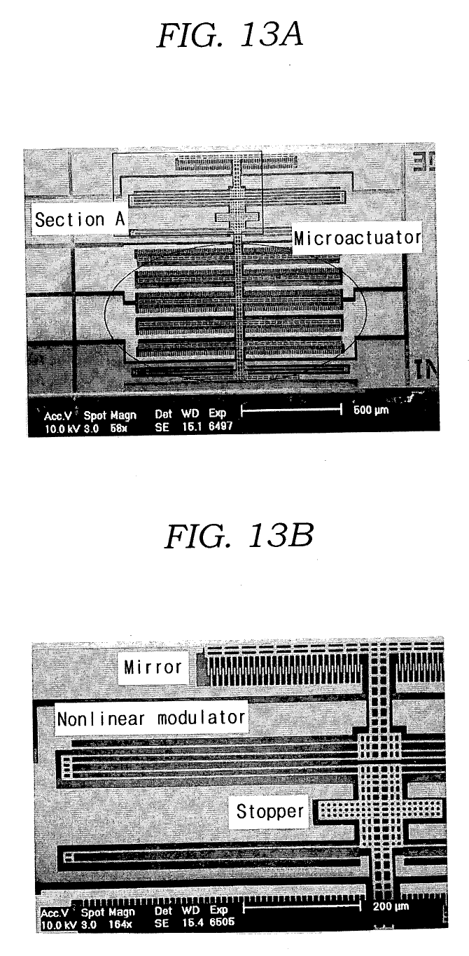

FIG. 11 shows the one-mask fabrication process for two different prototypes. The prototypes were defined by the deep RIE (Reactive Ion Etching) of the top silicon layer of SOI (Silicon On Insulator) wafer. FIGS. 12 and 13 show the fabricated linearly and nonlinearly modulated digital microactuators, respectively.

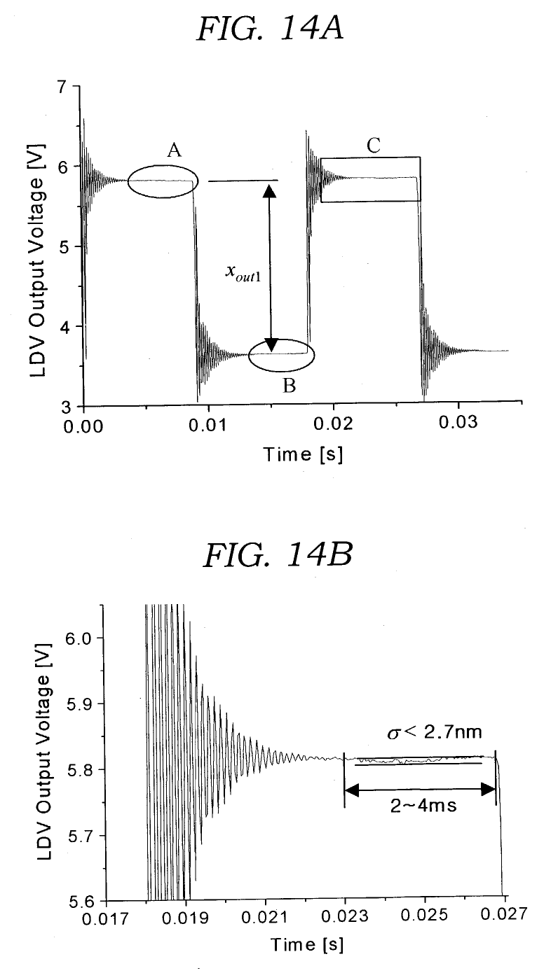

We experimentally demonstrate the feasibility of the NMDA that produces a purified motion stroke required for high-precision positioning devices. For a nano-precision measurement, we use the modified Mach-Zehnder interferometer, where laser beam has been focused on the micromirror attached to the second mass 2. The fabricated LMDA and NMDA are actuated digitally by applying two out-of-phase square wave signals of 60 Hz, 25V. FIG. 14a shows the interferometer output signals for the mirror displacement. The modulated displacement δXₒᵤₜ) has been measured from the distance between two stable portions (A and B in FIG. 14a). The measurement uncertainty of the modulated displacement output is 7.6 nm, due to the signal jitter (FIG. 14b) having a standard deviation of 2.7 nm.

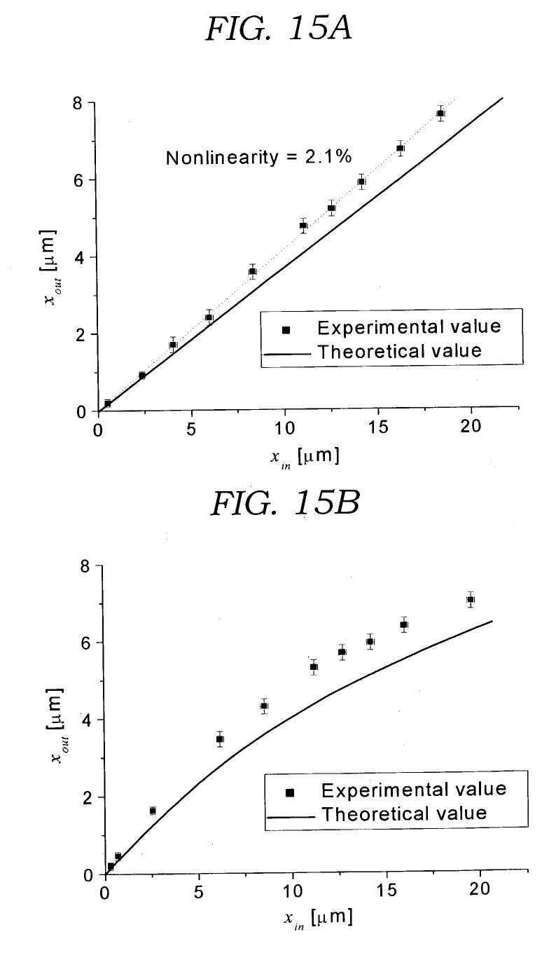

FIG. 15 compares the measured and estimated modulation curves of the fabricated micromechanical modulators for varying displacement input. The experimental values of the linear modulation curve are drawn as a linear line with the nonlinearlity of 2.1% and those of the nonlinear modulation curve coincides well with the theoretical nonlinear curve. For the precision evaluation, we have performed repeated motion output measurements (7 times) from the linearly and nonlinearly modulated digital microactuators, both producing the motion output in the range of 5.46±0.10 μm. Experimental values of the repeatability in Table 2 have been obtained from the double of the standard deviation in the repeated measurement. Table 2 demonstrates that NMDA produces the digital motion stroke with the repeatability of 12.3±2.9 nm, superior to that of 27.8±2.9 nm achieved by the LMDA. FIG. 15 and Table II demonstrate experimentally that the NMDA improves the repeatability of the motion output, compare to the conventional LMDA.

Here, in the first embodiment of the present invention, the fixed-fixed beam is employed as the nonlinear spring of which stiffness is increased as its deflection is increased. However, it is apparent to a person skilled in the art that another nonlinear spring of which stiffness is increased as its deflection is increased can be employed into the present invention instead of the fixed-fixed beam. It is also easily implemented.

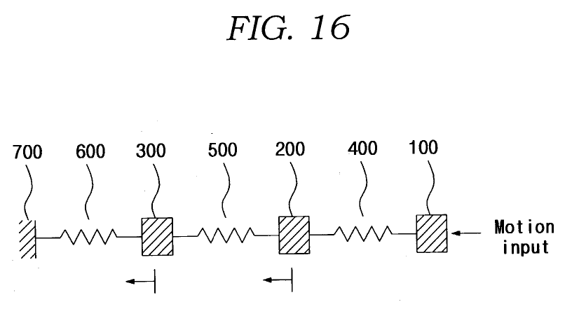

Hereinafter, a nonlinear mechanical modulator according to a second embodiment of the present invention will be explained with reference to FIG. 16.

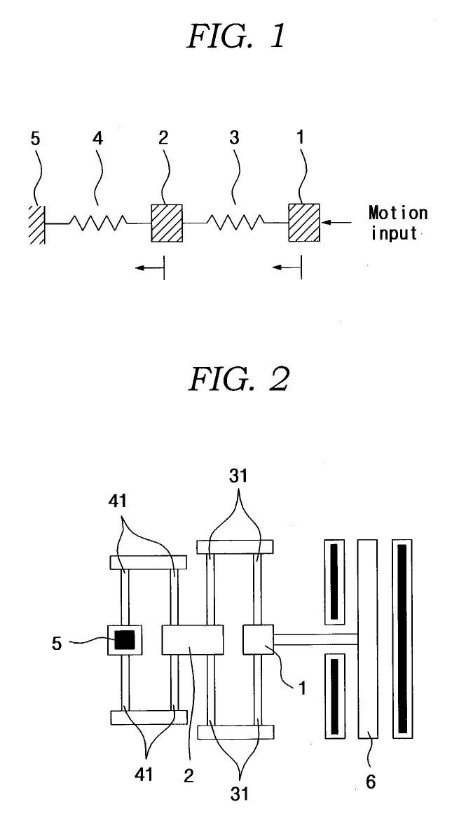

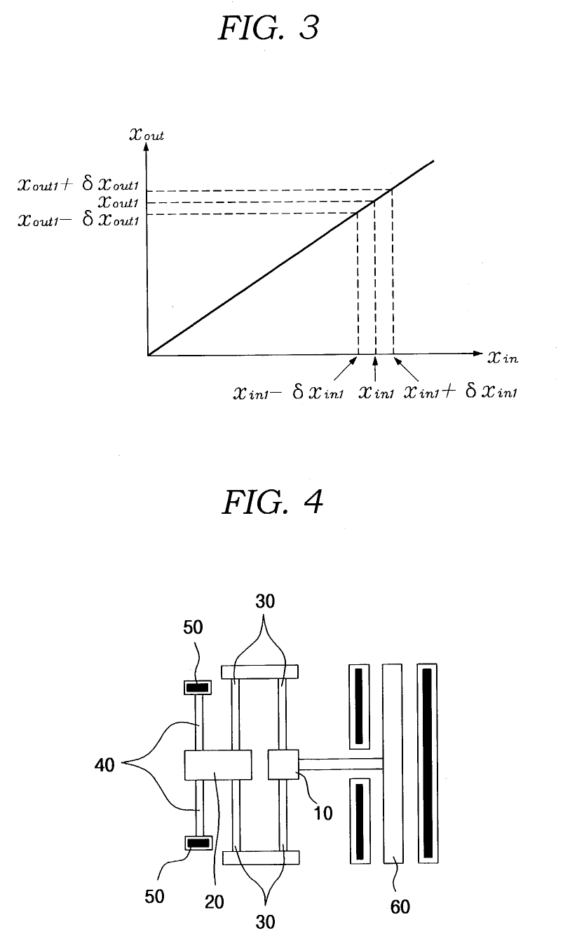

FIG. 16 conceptually shows the constitution of the nonlinear mechanical modulator according to the second embodiment of the present invention, with reference to FIG. 1. As shown in FIG. 16, the nonlinear mechanical modulator according to the second embodiment of the present invention comprises a first mass 100, a second mass 200, a third mass 300, at least one other mass (not shown), a first spring 400, a second spring 500, a third spring 600, at least one other spring (not shown), and a fixed end 700.

The second embodiment of the present invention corresponds to a case where at least one other mass and spring are further added to the first embodiment of the present invention.

The first mass 100 is subjected to a motion input and moved in a direction of the input. The movement of the first mass generates deflection of the respective springs. Thus, the respective springs exert elastic forces on the masses connected thereto, which in turn are moved to positions where the elastic forces are in equilibrium.

Here, assuming that the movement of the first mass is an motion input Xᵢₙ and a movement of n-th mass is an motion output, a relationship between the motion input and output is expressed as the following equation (6).

$${X}_{out} = \frac{{k}_{1} + Λ + {k}_{n - 1}}{{k}_{1} + {k}_{2} + {k}_{3} + Λ + {k}_{m}} \times {X}_{in} , \qquad ( 6 )$$

where kᵢ is the stiffness of an i-th spring, n is a serial number of the mass for the motion output, and m is a total number of the masses or springs.

Furthermore, in the second embodiment of the present invention, at least one of the springs (n-th to m-th springs) placed between the fixed end and the mass for the motion output (n-th mass) is the nonlinear spring with the nonlinearly increasing characteristic. It can be understood from the equation (6) that the second embodiment has a nonlinear modulation curve similar to FIG. 8.

Meanwhile, although it has been described that the springs having the nonlinearly increasing characteristics have been employed in the first and second embodiments of the present invention, it is apparent to the person skilled in the art that at least one of the springs placed between the mass for the motion input and the mass for the motion output may be used as the spring having the nonlinearly decreasing characteristic so that the object of the present invention can be easily achieved.

That is, it can be easily understood from the equations (1), (4) to (6) and the relationships [1] and [2] that the gradient of the modulation curve is decreased as the motion input is increased. Thus, the relative error of the motion output is smaller than that of the motion input, as in the first and second embodiments of the present invention.

Further, the object of the present invention can be easily achieved by using the spring with the nonlinearly decreasing characteristic and the spring with the nonlinearly increasing characteristic. At least one of the springs (first to (n−1)-th springs) placed between the mass for the motion input and the mass for the motion output is the nonlinear spring with the nonlinearly decreasing characteristic and at least one of the springs (n-th to m-th springs) placed between the fixed end and the mass for the motion output is the nonlinear spring having the nonlinearly increasing characteristic so that the object of the present invention can be easily achieved.

The nonlinear mechanical modulator of the present invention can be fabricated with a single process. If it is applied to and employed in an actuation system together with the nonlinear mechanical modulator and the actuator, the following operation can be performed.

In a case where the nonlinear mechanical modulator and the actuator according to the present invention are fabricated with the single process, an error in dimensions of the springs and the motion input error of the actuator can occur due to fabrication tolerance. Since the springs and the actuator are manufactured through the single process, this manufacturing tolerance almost similar to that in the dimensions of the springs and the motion input of the actuator in view of their magnitude.

First, considering a case where overetching occurs upon fabrication, since a motion input of the actuator is determined according to a width of an etched portion thereof, the motion input of the actuator becomes larger by an amount of the overetching. On the other hand, since a width of the beam in the mechanical modulator becomes smaller by the amount of the overetching, the gradient of the modulation curve is decreased. Thus, the modulation curve descends as a whole with respect to the positive motion input.

That is, due to the overetching, the motion input of the actuator tends to increase, but the increased motion input tends to decrease to a corresponding degree since the nonlinear mechanical modulation curve is also descends accordingly. Thus, if the dimensions of the actuator and the mechanical modulator are determined so that the motion output cannot be changed, the change of the motion input due to the overetching exerts no influence on the motion output.

A design for determining the magnitude of the motion input and the dimension of the nonlinear mechanical modulator may be similarly applied to a case of underetching. Thus, the change in the motion output due to the underetching can also be reduced.

According to the present invention, there is an advantage in that a problem in the conventional linear mechanical modulator that the relative error of the motion output is kept to be the same amount as the motion input can be overcome by reducing the relative error of the motion output with respect to the relative error of the motion input.

Further, there is another advantage in that even when the manufacturing tolerance occurs, the actuation system for generating a constant output can be provided by designing or determining the dimension of the nonlinear mechanical modulator and the magnitude of the motion input of the actuator so that the nonlinear characteristic of the mechanical modulator can compensate for the motion input change of the actuator.

Although the present invention has been described in connection with the preferred embodiments with reference to the accompanying drawings, the preferred embodiments are intended not to limit the invention but to exemplify a best mode of the present invention. It will be understood by those skilled in the art that various changes or modifications may be made thereto without departing from the spirit and scope of the invention. Therefore, the present invention is defined only by the appended claims which should be construed as covering such changes, modifications or adjustments.

TABLE I
Measured dimensions of the fabricated devices

| Structure thickness | | t | 40 | μm |
|---|---|---|---|---|
| Beam width | | w | 2.4 | μm |
| Length of beam 1 | | L₁ | 500 | μm |
| Length of | Linear modulator | (L₂)_{L} | 416 | μm |
| beam 2 | Nonlinear modulator | (L₂)_{NL} | 500 | μm |
| Digital input displacement | | xᵢₙ₁ | 15.2 | μm |
| Proof mass 1 | | m₁ | 13.5 | μg |
| Proof mass 2 | | m₂ | 2.53 | μg |
| Stiffness of spring 1 | | k₁ | 1.11 | N/m |
| Stiffness of | Linear modulator | (k₂)_{L} | 1.93 | N/m |

| | | | |
|---|---|---|---|
| spring 2 | Nonlinear modulator | (k₂)_{NL} | 1.11˜4.16 N/m |

TABLE II
Experimental and theoretical values
of the repeatability in the motion output
of the linearly and nonlinearly modulated digital microactuators

| Prototype | Device # | Experimental | Theoretical |
|---|---|---|---|
| LMDA | 1 | 25.2 ± 2.9 nm | 25.8 nm |
| | 2 | 32.6 ± 2.9 nm | |
| | 3 | 25.6 ± 2.9 nm | |
| NMDA | 1 | 11.6 ± 2.9 nm | 15.4 nm |
| | 2 | 11.0 ± 2.9 nm | |
| | 3 | 13.0 ± 2.9 nm | |
| | 4 | 13.4 ± 2.9 nm | |

What is claimed is:

1. A mechanical modulator, comprising:
first and second masses;
a first spring connecting the first and second masses; and
a second spring connecting the second mass and a fixed supporting end,
wherein an motion input is applied to any one of the first and second masses while a resultant motion output is generated from the other one of the masses, and at least one of the springs has a nonlinear behavior characteristic that its stiffness varies according to a magnitude of the motion input.

2. The modulator as claimed in claim 1, further comprising:
one or more masses and springs placed between the first spring and the second mass or between the second spring and the fixed supporting end,
wherein at least one of the springs has the nonlinear behavior characteristic that its stiffness varies according to a magnitude of the motion input.

3. The modulator as claimed in claim 2, wherein the motion input is applied to at least one mass and the motion output is generated from at least one mass.

4. An actuation system, comprising:
a mechanical modulator which includes first and second masses, a first spring connecting the first and second masses, and a second spring connecting the second mass and a fixed supporting end, and in which an motion input is applied to any one of the first and second masses and a resultant motion output is generated from the other one of the masses; and
an actuator for applying the motion input to the first or second mass,
wherein at least one of the springs of the mechanical modulator has a nonlinear behavior characteristic that its stiffness varies according to a magnitude of the motion input.

5. The actuation system as claimed in claim 4, wherein the mechanical modulator further includes one or more masses and springs placed between the first spring and the second mass or between the second spring and the fixed supporting end, and at least one of the springs has the nonlinear behavior characteristic that its stiffness varies according to a magnitude of the motion input.

6. The actuation system as claimed in claim 5, wherein the mechanical modulator includes at least one mass with an actuator incorporated therein, and the motion output is generated from at least one mass.

7. The actuation system as claimed in claim 4, wherein the sizes of the nonlinear mechanical modulators and the magnitudes of the digital motion input are decided in such a manner that when identical changes occur in dimensions of the mechanical modulators and the magnitudes of the motion input, the influence of the identical changes to the motion output is compensated and the motion output of the actuation system is remained in the constant magnitude.

8. The actuation system as claimed in claim 5, wherein the sizes of the nonlinear mechanical modulators and the magnitudes of the digital motion input are decided in such a manner that when identical changes occur in dimensions of the mechanical modulators and the magnitudes of the motion input, the influence of the identical changes to the motion output is compensated and the motion output of the actuation system is remained in the constant magnitude.

9. The actuation system as claimed in claim 6, wherein the sizes of the nonlinear mechanical modulators and the magnitudes of the digital motion input are decided in such a manner that when identical changes occur in dimensions of the mechanical modulators and the magnitudes of the motion input, the influence of the identical changes to the motion output is compensated and the motion output of the actuation system is remained in the constant magnitude.
